(19) United States
(12) Patent Application Publication
(10) Pub. No.: US 2026/0127379 A1
(43) Pub. Date: May 7, 2026

(54) METHOD, APPARATUS AND COMPUTER-READABLE MEDIUM FOR IDENTIFYING MICRO BIASED TEXT WITHIN OPEN CORPORA AND GENERATING RESPONSE TO IDENTIFIED MICRO BIASED TEXT

(71) Applicant: Saltlux Inc., Seoul (KR)

(72) Inventors: Jai Eun KIM, Goyang-si (KR); Sang Min PARK, Goyang-si (KR)

(21) Appl. No.: 18/986,797

(22) Filed: Dec. 19, 2024

(30) Foreign Application Priority Data
Nov. 7, 2024 (KR) 10-2024-0157024

(51) Int. Cl. G06F 40/30; G06F 18/241; G06F 40/40

(52) U.S. Cl. CPC G06F 40/30; G06F 18/241; G06F 40/40

(57) ABSTRACT

Provided is a method for identifying subtly biased texts within open corpora, which includes: a natural language sentence collecting step of collecting natural language sentences from text-based datasets including open conversation datasets and web corpus datasets; a bias candidate dataset obtaining step of comparing semantic vectors between words composing the natural language sentences by using a word-embedding model from the collected natural language sentences, thereby obtaining a bias candidate dataset including seed bias data expected to be socially and ethically biased and derived bias data expanded from the seed bias data; and a bias determining step of determining the bias candidate dataset as one of a surficial bias dataset, a subtle bias dataset, and a non-bias dataset by using multiple large-scale language models.

### BACKGROUND OF THE INVENTION

### 1. Field of the Invention

The present invention relates to a method for identifying subtly biased text within open corpora and generating a response to the identified subtly biased text, and more particularly, to a technology of identifying texts having latent biases that are not explicitly apparent in the open corpora to establish data on subtle bias and performing learning on the established data, thereby detecting wrong biases of large-scale language models, so as to solve degradation of reliability and performance for the large-scale language models.

### 2. Description of the Related Art

Recently, along with development of artificial intelligence technology, natural language processing technology has been also rapidly developing. In particular, performance of natural language tasks has been dramatically improved with the release of translation machines to which self-attention and multi-head attention technologies among various models for neural machine translation are applied. The BERT model, which uses only the encoder block of a translation machine, has greatly contributed to the revival of deep learning technology for processing natural languages, and the GPT3 model, which uses only the decoder block, has opened a new chapter in natural language generation by artificial intelligence through learning on huge corpora.

However, the development of artificial intelligence technology (that is, large-scale language models) in the field of natural language processing has faced ethical issues on artificial intelligence, such as the ‘ILuda (Luda.ai) controversy’. In other words, the artificial intelligence having learned various hate speech, personal information and politically/ethically biased information present in data input for learning mechanically may provide biased predictions and results without any sense of guilt, and this problem may not only cause a fatal weakness in reliability on large-scale language models, but also cause a major limitation to commercialization.

Accordingly, Korean Unexamined Patent publication No. 10-2023-0075890 (Language model output device and method with removed bias), proposes a language model output technology for determining biases and removing generated bias information by removing modules to remove bias through human intervention in the process of deep learning.

Meanwhile, the above-mentioned related art is technology that removes biases by comparing and reviewing biased information generated by large-scale language models with main information constructed through human intervention. Accordingly, there is a high possibility of human error due to the human intervention, and it is difficult to identify subtle biases that are not explicitly apparent even when explicitly apparent biases are identified, and thus there may be a limitation in solving deterioration of reliability on large-scale language models.

### SUMMARY OF THE INVENTION

In this regard, a primary object of the present invention is to provide technology for allowing a large-scale language model to identify texts having subtle biases (or latent biases), which are not explicitly apparent in open corpora, corresponding to biases that cannot be easily detected by the large-scale language model.

In addition, a secondary object of the present invention is to provide technology for generating and providing unbiased response answers when a large-scale language model receives a question about an identified subtly biased text, so that fairness, ethics and reliability of the large-scale language model may be promoted.

In order to achieve the above objects, a method implemented by a computing device including one or more processors and one or more memories for storing instructions executable in the processors according to one embodiment of the present invention to identify subtly biased texts within open corpora includes: a natural language sentence collecting step of collecting natural language sentences from text-based datasets including open conversation datasets and web corpus datasets; a bias candidate dataset obtaining step of comparing semantic vectors between words composing the natural language sentences by using a word-embedding model from the collected natural language sentences, thereby obtaining a bias candidate dataset expected to be socially and ethically biased; and a bias determining step of determining the bias candidate dataset as one of a surficial bias dataset, a subtle bias dataset, and a non-bias dataset by using multiple large-scale language models.

The bias determining step may include using, as the multiple large-scale language models, heterogeneous large-scale language models having different structures and training mechanisms.

In addition, when each of the multiple large-scale language models performs bias determination on one bias candidate dataset subject to the bias determination and when all of the large-scale language models determine the one bias candidate dataset as a biased dataset, the bias determining step may include classifying the one bias candidate dataset as the bias dataset.

In addition, when each of the multiple large-scale language models performs bias determination on one bias candidate dataset subject to the bias determination and when all of the large-scale language models determine the one bias candidate dataset as a unbiased dataset, the bias determining step may include classifying the one bias candidate dataset as the non-bias dataset.

In addition, when each of the multiple large-scale language models performs bias determination on one bias candidate dataset subject to the bias determination and when at least one of the large-scale language models determines the one bias candidate dataset as a biased dataset, the bias determining step may include classifying the one bias candidate dataset as the subtle bias dataset. it may be preferable that.

In addition, when each of the multiple large-scale language models performs bias determination on one bias candidate dataset subject to the bias determination and when the multiple large-scale language models provide different results on the bias determination, the bias determining step may include, based on the majority rule, classifying the one bias candidate dataset as the subtle bias dataset when there are a majority of determinations on ‘biased’ and classifying the one bias candidate dataset as the non-bias dataset when there are a majority of determinations on ‘non-bias’.

In addition, the method further includes: a determination criterion querying step, when the one bias candidate dataset is classified as the subtle bias dataset by performing the bias determining step, of querying a determination criterion to the large-scale language model having obtained the classification results as the subtle bias dataset; a response validity determining step, when a response returned by the large-scale language model is present by performing the determination criterion querying step, of determining validity of the returned response; and a learning dataset storing step of classifying the subtle bias dataset, which is obtained as the valid response in the response validity determining step, as a learning dataset for self-learning to store the classified the subtle bias dataset in a learning database.

In addition, the response validity determining step may include determining the response as a valid response when a factor containing at least one of keywords and ideas containing social and ethical issues is obtained from the response returned by the large-scale language model.

In addition, the method further includes a self-learning step, after the bias determining step is performed, of performing self-learning by providing subtle bias-related learning data to the multiple large-scale language models by using the learning data sets stored in the learning database.

Meanwhile, a method implemented by a computing device including one or more processors and one or more memories for storing instructions executable in the processors according to another embodiment of the present invention to identify subtly biased text within open corpora and generate a response to the identified subtly biased text includes: a natural language sentence collecting step of collecting natural language sentences from text-based datasets including open conversation datasets and web corpus datasets; a bias candidate dataset obtaining step of comparing semantic vectors between words composing the natural language sentences by using a word-embedding model from the collected natural language sentences, thereby obtaining a bias candidate dataset expected to be socially and ethically biased; a bias determining step of determining the bias candidate dataset as one of a surficial bias dataset, a subtle bias dataset, and a non-bias dataset by using multiple large-scale language models; and a response answer generating step of generating a response answer for the natural language sentence identified as the surficial bias dataset and the subtle bias dataset so as to generate a response answer in which bias is mitigated or removed.

The response answer generating step may include generating the response answer to the natural language sentence having identified bias in a format that includes at least one of a summary format and a detailed description format.

In addition, the bias determining step may include: a bias determination result receiving step of receiving bias determination results for the one bias candidate dataset from the multiple large-scale language models; a bias score calculating step of calculating a bias score for the one bias candidate dataset based on the majority rule by aggregating the received bias determination results; and a bias intensity defining step of defining a bias intensity for the one bias candidate dataset based on the calculated bias score.

In addition, a trust level may be defined for each of the large-scale language models based on a trust level management model preset for the multiple large-scale language models, and the bias score calculating step may include calculating the bias score by giving the highest weight to the bias determination result provided by the large-scale language model defined with the highest trust level.

In addition, the bias intensity defining step may include defining the one bias candidate dataset as a first bias level when the calculated bias score is less than the threshold bias score, and defining the one bias candidate dataset as a second bias level when the calculated bias score is greater than or equal to the threshold bias score.

In addition, when the bias intensity defined for the one bias candidate dataset is the first bias level, the response answer generating step may include generating a first response answer, which is a response answer composed of correction information that corrects the bias.

In addition, when the bias intensity defined for the one bias candidate dataset is the second bias level, the response answer generating step may include generating a second response answer, which is a response answer composed of warning information that warns of the bias, together with the correction information that corrects the bias.

Meanwhile, an apparatus implemented by a computing device including one or more processors and one or more memories for storing instructions executable in the processors to identify subtly biased texts within open corpora includes: a natural language sentence collecting unit for collecting natural language sentences from text-based datasets including open conversation datasets and web corpus datasets; compares semantic vectors between words composing the natural language sentences by using a word-embedding model from the collected natural language sentences, a bias candidate dataset obtaining unit for obtaining a bias candidate dataset expected to be socially and ethically biased; and a bias determining unit for determining the bias candidate dataset as one of a surficial bias dataset, a subtle bias dataset, and a non-bias dataset by using multiple large-scale language models.

In addition, an apparatus implemented by a computing device including one or more processors and one or more memories for storing instructions executable in the processors to identify subtly biased texts within open corpora and generate a response to the identified subtly biased texts includes: a text data collecting unit for collecting natural language sentences from text-based datasets including open conversation datasets and web corpus datasets; a bias candidate dataset obtaining unit for comparing semantic vectors between words composing the natural language sentences by using a word-embedding model from the collected natural language sentences, thereby obtaining a bias candidate dataset socially and ethically biased; a bias determining unit for determining the bias candidate dataset, which is obtained from the bias candidate dataset obtaining unit, as one of a surficial bias dataset, a subtle bias dataset, and a non-bias dataset by using multiple large-scale language models; and a response answer generating unit for generating a response answer for the natural language sentence identified as the surficial bias dataset and the subtle bias dataset in the bias determining unit so as to generate a response answer in which bias is mitigated or removed.

On the other hand, a computer-readable recording medium, stores instructions for allowing a computing device to perform the following steps including: a natural language sentence collecting step of collecting natural language sentences from text-based datasets including open conversation datasets and web corpus datasets; a bias candidate dataset obtaining step of comparing semantic vectors between words composing the natural language sentences by using a word-embedding model from the collected natural language sentences, thereby obtaining a bias candidate dataset expected to be socially and ethically biased; and a bias determining step of determining the bias candidate dataset as one of a surficial bias dataset, a subtle bias dataset, and a non-bias dataset by using multiple large-scale language models.

In addition, the computer-readable recording medium according to another embodiment of the present invention stores instructions for allowing a computing device to perform the following steps including: a natural language sentence collecting step of collecting natural language sentences from text-based datasets including open conversation datasets and web corpus datasets; a bias candidate dataset obtaining step of comparing semantic vectors between words composing the natural language sentences by using a word-embedding model from the collected natural language sentences, thereby obtaining a bias candidate dataset expected to be socially and ethically biased; a bias determining step of determining the bias candidate dataset as one of a surficial bias dataset, a subtle bias dataset, and a non-bias dataset by using multiple large-scale language models; and a response answer generating step of generating a response answer for the natural language sentence identified as the surficial bias dataset and the subtle bias dataset so as to generate a response answer in which bias is mitigated or removed.

According to one embodiment of the present invention, the present invention provides the technology for allowing a large-scale language model to identify texts having subtle biases (or latent biases), which are not explicitly apparent in open corpora, corresponding to biases that cannot be easily detected by the large-scale language model, so that the problem of reduced user reliability due to the inability of large-scale language models to detect biases that are not explicitly apparent can be solved.

In addition, according to one embodiment of the present invention, the present invention functions to generate a response answer having mitigated or removed bias for a natural language sentence in which bias or subtle bias is identified, so that user experience can be improved by providing fair services to all users, and social prejudice and discrimination can be reduced.

### BRIEF DESCRIPTION OF THE DRAWINGS

FIGS. 1, 9 and 10 are flowcharts showing a method for identifying subtly biased texts within open corpora according to one embodiment of the present invention.

FIG. 2 is an example of sources for collecting natural language sentences according to one embodiment of the present invention.

FIGS. 3A, 3B and 3C are conceptual examples for classifying apparently biased, subtly biased, and unbiased sentences according to one embodiment of the present invention.

FIG. 4 is a conceptual diagram showing multiple LLM models for classifying natural language sentences according to one embodiment of the present invention.

FIGS. 5 to 8 are examples of determination on biases of natural language sentences performed by multiple LLMs according to one embodiment of the present invention.

FIGS. 11 and 13 are flowcharts showing a method for identifying subtly biased texts within open corpora and generating a response to the identified subtly biased texts according to one embodiment of the present invention.

FIG. 12 shows examples of generated formats of response answers according to one embodiment of the present invention.

FIG. 14 shows examples of generation structures of response answers according to one embodiment of the present invention.

FIG. 15 is a schematic diagram of showing an apparatus for identifying subtly biased texts within open corpora according to one embodiment of the present invention.

FIG. 16 is a schematic diagram showing an apparatus for identifying subtly biased texts within open corpora and generating a response to the identified subtly biased texts according to one embodiment of the present invention.

FIG. 17 shows one example of an internal configuration of a computing device according to one embodiment of the present invention.

### DETAILED DESCRIPTION OF THE INVENTION

Hereinafter, various embodiments and/or aspects will be described with reference to the drawings. In the following description, a plurality of specific details are set forth to provide comprehensive understanding of one or more aspects for the purpose of explanation. However, it will also be appreciated by a person having ordinary skill in the art that such aspect(s) may be carried out without the specific details. The following description and accompanying drawings will be set forth in detail for specific exemplary aspects among one or more aspects. However, the aspects are merely exemplary and some of various ways among principles of the various aspects may be employed, and the descriptions set forth herein are intended to include all the various aspects and equivalents thereof.

The terms “embodiment”, “example”, “aspect” and the like used in the present specification may not be construed in that an aspect or design set forth herein is preferable or advantageous than other aspects or designs.

In addition, it will be understood that the terms “include” and/or “comprise” specify the presence of the corresponding feature and/or element, but do not preclude the possibility of the presence or addition of one or more other features, elements or combinations thereof.

In addition, the terms including an ordinal number such as first and second may be used to describe various elements, however, the elements are not limited by the terms. The terms are used only for the purpose of distinguishing one element from another element. For example, the first element may be referred to as the second element without departing from the scope of the present invention, and similarly, the second element may also be referred to as the first element. The term “and/or” includes any one of a plurality of related listed items or a combination thereof.

In addition, all terms used herein including technical or scientific terms have the same meaning as commonly understood by those having ordinary skill in the art unless defined otherwise in embodiments of the present invention. Terms such as those defined in generally used dictionaries will be interpreted to have the meaning consistent with the meaning in the context of the related art, and will not be interpreted as an ideal or excessively formal meaning unless clearly defined in the embodiments of the present invention.

The present invention relates to a method for identifying subtly biased text within open corpora and generating a response to the identified subtly biased text, and more particularly, a primary object is to provide technology for allowing a large-scale language model to identify texts having subtle biases (or latent biases), which are not explicitly apparent in open corpora, corresponding to biases that cannot be easily detected by the large-scale language model, and a secondary object is to provide technology for generating and providing unbiased response answers when a large-scale language model receives a question about an identified subtly biased text, so that fairness, ethics and reliability of the large-scale language model may be promoted.

Hereinafter, the present invention for achieving the above-mentioned objects will be described in detail with reference to the accompanying drawings, and a plurality of drawings may be simultaneously referenced in order to describe one or more technical features or elements constituting the present invention.

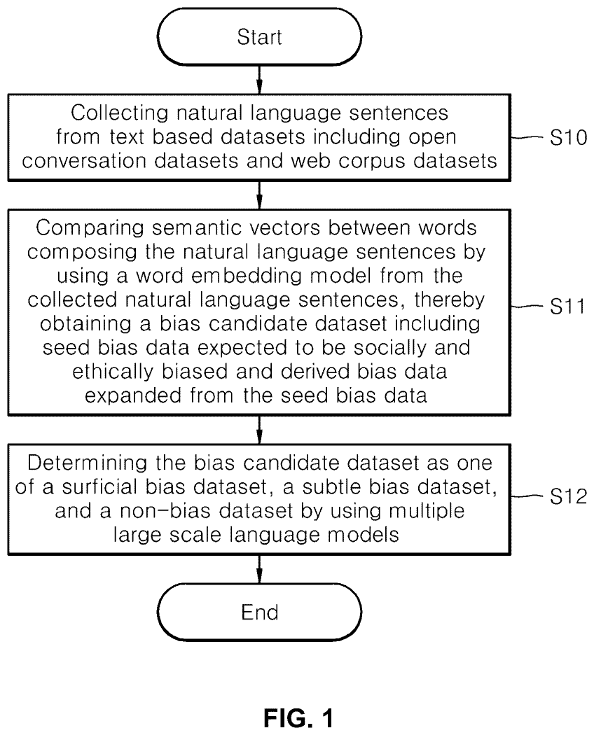

First, the present invention will be described with reference to FIG. 1 showing a flow chart of a method for identifying subtly biased texts within open corpora.

As shown in FIG. 1, the method for identifying subtly biased texts within open corpora according to one embodiment of the present invention includes: a natural language sentence collecting step S10 of collecting natural language sentences from text-based datasets including open conversation datasets and web corpus datasets.

In step S10, the natural language sentences are collected from the open conversation datasets and the web corpus datasets as described above.

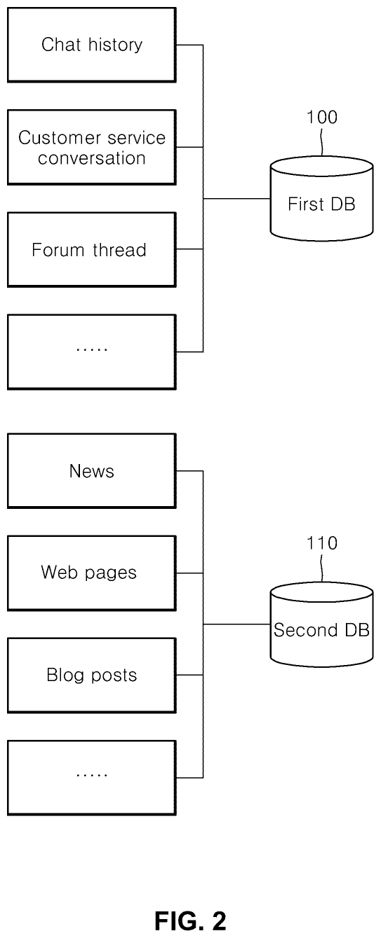

Referring to FIG. 2 together as one embodiment, the conversation datasets may be understood as text-based datasets composed of conversations between people, such as chat records, customer service conversations and forum threads, and the web corpus datasets refer to various text-based datasets collected on the web and may include news, web pages, blog posts, and the like.

Meanwhile, the conversation datasets and the web corpus datasets may be stored in a first database 100 and a second database 110, respectively, and each of the databases may be periodically updated, so that natural language sentences reflecting recent trends may be collected, however, the present invention is not limited thereto.

Referring back to the description of FIG. 1, a bias candidate dataset obtaining step S11 is performed, after performing step S10, of comparing semantic vectors between words composing the natural language sentences by using a word-embedding model from the collected natural language sentences, thereby obtaining a bias candidate dataset including seed bias data expected to be socially and ethically biased and derived bias data expanded from the seed bias data.

As one embodiment, the word-embedding model mentioned in step S20 refers to a scheme of representing words as dense vectors in a high-dimensional vector space, and signifies a technology for converting words into a format to be understood by a computer in natural language processing.

The word-embedding model aims to represent semantic relationships between words in a vector space in which words having similar meanings are represented by similar vectors, and words having different meanings are represented by different vectors.

As one embodiment, the word-embedding model mentioned in the present invention may be trained through a neural network-based model. As a specific example, an algorithm including at least one of Word2Vec, Global vectors for word representation (GloVe), and FastText may be used for an algorithm of the word-embedding model.

The Word2Vec refers to a neural network-based word-embedding algorithm and uses a model structure including at least one of a model structure, such as Continuous Bag of Words (CBOW), for predicting a central word based on context of surrounding words using, and a model structure, such as Skip-gram, for predicting surrounding words based on a central word, and may learn relationships between words surrounding a specific word, thereby expressing semantic similarity between the words as a vector.

In addition, the GloVe learns relationships between words in a global context by using a word co-occurrence matrix. As one embodiment, the above-described Word2Vec focuses on the center word, however, the GloVe collects the frequency of words appearing together in the entire sentence, reflecting the overall statistical relationship, thereby learning word vectors.

In addition, the FastText is characterized in effectively performing morphological analysis by dividing words into character units (tokens) for learning. Accordingly, it may also flexibly respond to similarity calculations of new words or compound words that have not been previously learned.

Meanwhile, in step S11, a process, of converting each word constituting a natural language sentence into a vector by using the word-embedding model, precedes. The converted vector reflects a meaning of the word in context, and may be useful for analyzing semantic similarities and relationships between words.

As one embodiment, the vectors generated through the word-embedding may be compared mathematically. For example, the similarity between vectors may be measured using schemes, such as cosine similarity or Euclidean distance, thereby analyzing the relationships between words. In the case of cosine similarity, when an angle between words is compared, the angle closer to 0 signifies that the two words are similar more. In the case of Euclidean distance, when a straight-line distance between vectors, is calculated, the closer distance signifies that the two words are similar more.

In the present invention, when unusually strong semantic associations may be detected between words related to specific social groups, genders, races, and religions, for example, when “female” and “emotional” are represented by very close vectors in a natural language sentence, the natural language sentence may be determined to have a bias reflecting gender stereotypes.

In other words, in step S11 of the present invention, it may be understood that whether the natural language sentence has a keyword related to a specific social group, gender, race or religion and having the possibility to cause social/ethical issues is checked, and the natural language sentence is processed to be obtained as a bias candidate dataset.

The keyword having the possibility to cause social/ethical issues may be defined in advance as keywords related to the social group, gender, race or religion, and processed through comparison with the predefined keyword, however, the present invention is not limited thereto.

In particular, S11 step is characterized in that sentences detected to have bias in the natural language sentences collected in step S10 are collected as seed bias data, and then derived bias data is obtained by expanding the collected seed bias data. The derived bias data is not directly collected as seed bias data, however, may be understood as a value obtained by applying seed bias data to the word-embedding model to expand a meaning thereof, resulting in a sentences having a similar meaning.

Specifically, the derived bias data obtained by expanding the seed bias data may be understood as replacing a specific word in the seed bias data with another word having a similar meaning, reconstructing a specific sentence in the seed bias data to have a similar meaning, or adding additional data to the seed bias data to reflect diverse perspectives and opinions. According to the present invention, bias candidate data is obtained using the seed bias data and the derived bias data as described above, so that accuracy on the bias determination can be increased and self-feedback can be performed.

Next, after performing step S11, a bias determining step S12 is performed of determining the bias candidate dataset as one of a surficial bias dataset, a subtle bias dataset, and a non-bias dataset by using multiple large-scale language models.

In general, in order to detect whether bias is present in the natural language sentence, it is checked whether a topic containing a discriminatory factor is explicitly or implicitly included in the natural language sentence, and accordingly, it is determined as a surficial bias natural language sentence when an explicit factor is included, it is determined as a subtle bias natural language sentence when an implicit factor is included, or it is determined as a non-bias natural language sentence, which is not biased, when an explicit or implicit factor is not included.

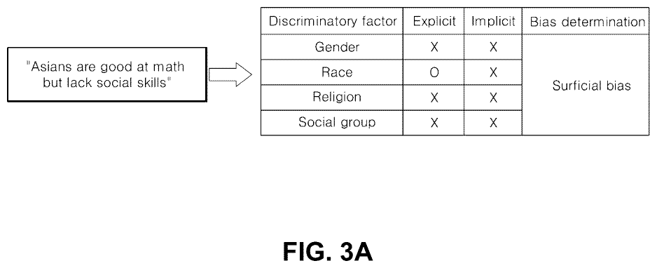

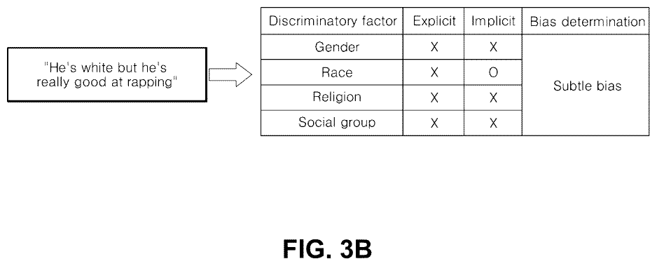

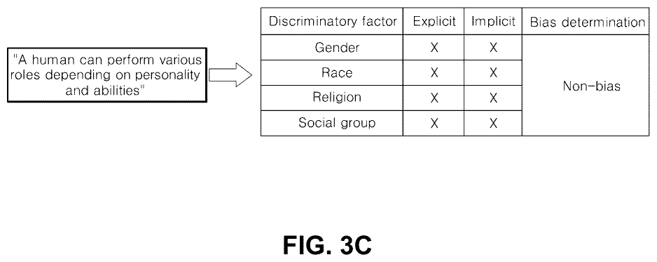

Referring to FIG. 3 as one embodiment, FIGS. 3A, 3B and 3C show examples of the surficial bias natural language sentences, the subtle bias natural language sentences, and the non-bias natural language sentence, respectively.

First, referring to FIG. 3A, it can see that the natural language sentence “Asians are good at math but lack social skills” explicitly has several keywords including racial stereotypes, and accordingly, may be classified as the surficial bias natural language sentence.

Next, referring to FIG. 3B, the natural language sentence “He's white, but he's really good at rapping” appears. This natural language sentence implies that it is unusual for a certain race to be good at rapping and includes stereotypes about abilities of the certain race, and accordingly, may be classified as the subtle bias natural language sentence.

Next, referring to FIG. 3C, the natural language sentence “A human can perform various roles depending on personality and abilities” appears. This natural language sentence does not contain any stereotypes about a specific gender, a specific race, a specific religion, or a specific social group, and accordingly, may be classified as the non-bias natural language sentence.

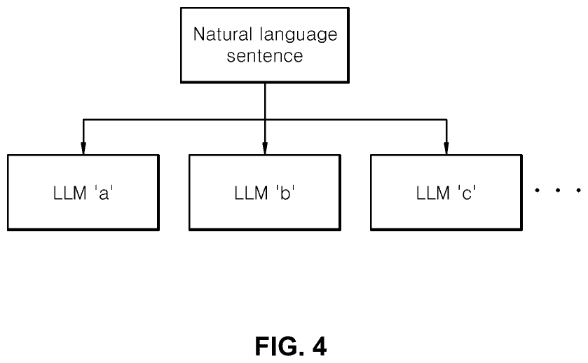

Meanwhile, in step S12 of the present invention, multiple large-scale language models are used to perform bias determination on one bias candidate dataset subjected to the bias determination based on the above bias determination criterion. More preferably, as shown in the conceptual diagram of FIG. 4, heterogeneous large-scale language models having different structures and training mechanisms may be used.

As one embodiment, when two types of large-scale language models are used, heterogeneous large-scale language models, such as a BERT-based large-scale language model and a GPT-based large-scale language model, having different learning approaches and text processing schemes may be used to determine biases of natural language sentences.

The BERT-based large-scale language model has the characteristic of considering the context before and after a sentence through bidirectional learning centered on a specific word, and thus deeply understands the meaning of the word according to the context. The GPT-based large-scale language model uses unidirectional learning to generate words and predict a sentence sequentially from the beginning. Accordingly, the bias analysis related to the natural flow of sentences may be efficiently performed.

As one embodiment, regarding the natural language sentence “Women are delicate and accordingly, emotional”, the BERT-based large-scale language model has excellent performance on identifying contextual biases (that is, detecting implicit biases) that reflect subtle stereotypes about women while linking “delicate” to “emotional”. Regarding the natural language sentence “She was successful as a CEO, but this case is rare for women”, the GPT-based large-scale language model has excellent performance on identifying biases that occur in the process of generating a sentence (easily detecting implicit biases or pattern biases), such as “it is rare for women”, by learning the natural flow of words.

In other words, according to the present invention, the characteristics of the BERT-based large-scale language model for deeply understanding context and detecting subtle contextual biases more effectively, and the characteristics of the GPT-based large-scale language model for identifying biases occurring in the sentence generation flow may be used complementarily to each other, so that various aspects of bias that are difficult to detect with a single large-scale language model can be identified with high accuracy, and accordingly, better ethical artificial intelligence systems can be costructed and services for fulfilling social responsibility can be provided.

Meanwhile, in step S12 of the present invention, when the multiple large-scale language models are used to perform bias determination on one bias candidate dataset subject to the bias determination, detailed classification criterion may be provided to classify whether the one bias candidate dataset is surficially biased, subtly biased, or unbiased. As one embodiment, in the present invention, when each of the multiple large-scale language models is used to perform bias determination on one bias candidate dataset subject to the bias determination and when all of the large-scale language models determine the one bias candidate dataset as a biased dataset, the one bias candidate dataset may be classified as the surface bias dataset.

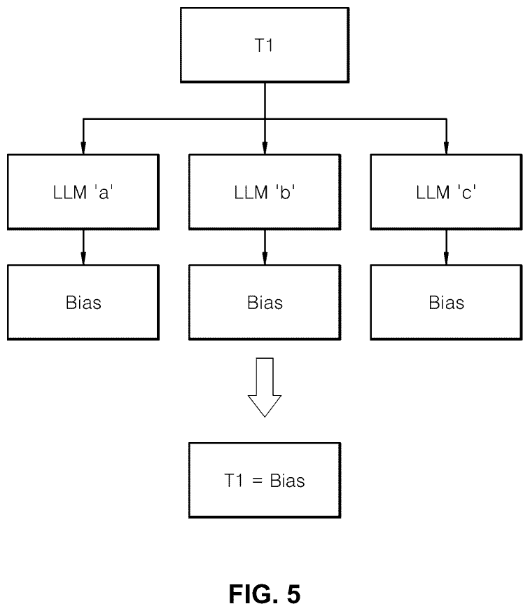

This concept will be described with reference to the FIG. 5. For example, with respect to a natural language sentence T1 subject to the bias determination, large-scale language models ‘a’, ‘b’, and ‘c’ are used as the multiple large-scale language models for performing bias determination. When these large-scale language models determine that the natural language sentence T1 has a bias, the natural language sentence T1 may be classified as the surficial bias dataset in step S12 of the present invention.

In addition, as one embodiment according to the present invention, when each of the multiple large-scale language models is used to perform bias determination on one bias candidate dataset subject to the bias determination and when all of the large-scale language models determine the one bias candidate dataset as a unbiased dataset, the one bias candidate dataset may be classified as an unbiased dataset, that is, the non-biased dataset.

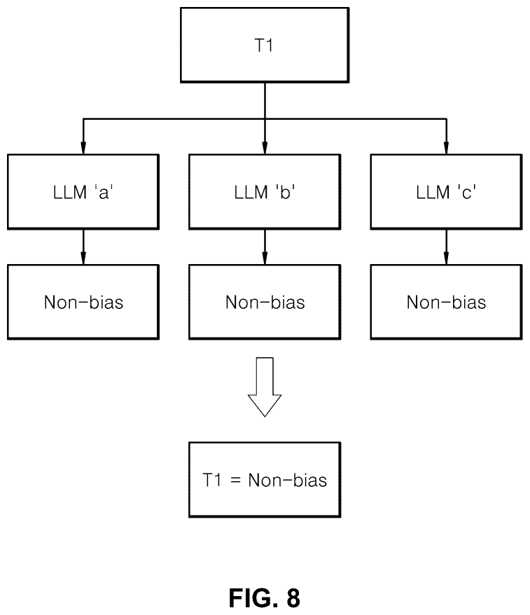

This concept will be described with reference to the FIG. 8. For example, with respect to a natural language sentence T1 subject to the bias determination, large-scale language models ‘a’, ‘b’, and ‘c’ are used as the multiple large-scale language models for performing bias determination. When these large-scale language models determine that the natural language sentence T1 is unbiased, the natural language sentence T1 may be classified as the non-bias dataset in step S12 of the present invention.

In addition, as one embodiment according to the present invention, when each of the multiple large-scale language models performs bias determination on one bias candidate dataset subject to the bias determination and when at least one of the large-scale language models determines the one bias candidate dataset as a biased dataset, the one bias candidate dataset may be classified as the subtle bias dataset.

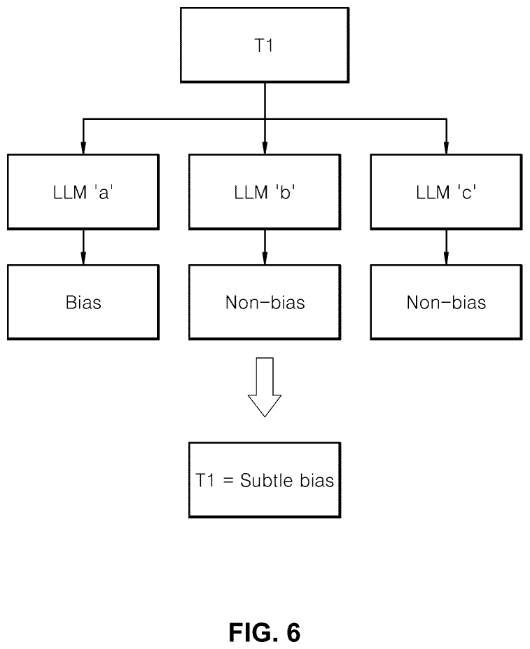

This concept will be described with reference to the FIG. 6. For example, with respect to a natural language sentence T1 subject to the bias determination, large-scale language models ‘a’, ‘b’, and ‘c’ are used as the multiple large-scale language models for performing bias determination. When, among the large-scale language models, ‘a’ determines the natural language sentence T1 as a biased dataset, and ‘b’ and ‘c’ determine the natural language sentence T1 as a unbiased dataset, the natural language sentence T1 is classified as the subtle bias dataset in the present invention.

In other words, according to the present invention, when at least one large-scale language model among the multiple large-scale language models determines that the natural language sentence T1 subject to the bias determination is biased, the natural language sentence T1 is determined as having a possible bias, so that a dataset having subtle biases that are not explicitly apparent may be easily identified.

In another embodiment of the present invention, for identifying the subtle bias, when each of the multiple large-scale language models performs bias determination on the natural language sentences T1, which is one bias candidate dataset subject to the bias determination, and when the multiple large-scale language models provide different results on the bias determination, the one bias candidate dataset may be classified, based on the majority rule, as the subtle bias dataset when there are a majority of determinations on ‘biased’ and the one bias candidate dataset may be classified as the non-bias dataset when there are a majority of determinations on ‘non-bias’.

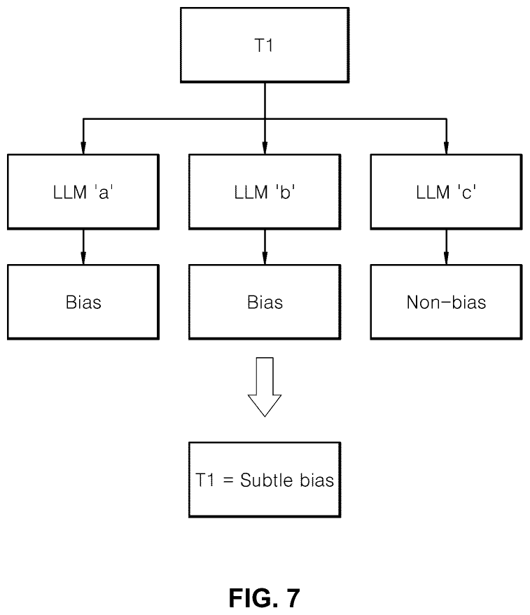

Referring to FIG. 7 as one embodiment, FIG. 7 shows a conceptual diagram of an example in which, as a result of performing the bias determination on the natural language sentence T1 subject to the bias determination by the multiple large-scale language models, a majority of multiple large-scale language models determine the natural language sentence T1 as being biased, and accordingly, the natural language sentence T1 is classified as the subtle bias dataset.

In still another embodiment of the present invention, reliability may be managed on the multiple large-scale language models, so that bias determination based on the majority rule and the individual reliability of large-scale language models may be performed.

In other words, based on the reliability of the large-scale language models, for example, the highest weight may be given to the determination result provided by the large-scale language model having the highest reliability, and the lowest weight may be given to the determination result provided by the large-scale language model having the lowest reliability. Thus, different weights may be given according to evaluated reliability on the large-scale language models, so that bias determination results for natural language sentences may be obtained from the multiple large-scale language models.

Meanwhile, the reliability of the large-scale language model may be evaluated and managed by the following evaluation approaches.

As one embodiment, according to the present invention, in order to perform bias determination according to the reliability of large-scale language models, an accuracy evaluation may be performed on the large-scale language models. For example, in order to determine whether the response of a large-scale language model is factually accurate, a question having an answer key may be provided to a large-scale language model and then an accurate match of the response returned by the large-scale language model may be determined by an actual correct answer, thereby evaluating the reliability.

In addition, as one embodiment according to the present invention, in order to perform bias determination according to the reliability of large-scale language models, a consistency evaluation may be performed on the large-scale language models. For example, it may be evaluated on whether the large-scale language model provides consistent answers to the same question or in similar context. It may be determined whether the large-scale language model provides consistent answers when repeated questions are asked in the same situation or phrased questions are slightly changed, thereby evaluating the reliability.

In addition, as one embodiment according to the present invention, in order to perform bias determination according to the reliability of large-scale language models, a stability evaluation may be performed. For example, it is examined how effectively the large-scale language model responds to input variations. For example, it may be checked whether the large-scale language model still returns a correct response or obtains and returns a meaningful response even for inputs with typo omissions and errors or grammatical errors, thereby evaluating the reliability.

In addition, as one embodiment according to the present invention, in order to perform bias determination according to the reliability of large-scale language models, whether a response is factual may be evaluated. This evaluation refers to evaluating how accurately responses returned by the large-scale language model are consistent with facts. it may be checked whether the responses returned by the large-scale language model are actually based on trustworthy sources, thereby evaluating the reliability.

In addition, as one embodiment according to the present invention, in order to perform bias determination according to the reliability of large-scale language models, a user satisfaction evaluation may be performed. This evaluation refers to evaluating how sufficiently actual users of the large-scale language model are satisfied with the performance of large-scale language model. It may be evaluated how substantially the responses from the large-scale language model actually are helpful to solve problems, thereby evaluating the reliability.

In the present invention, the reliability of the large-scale language models may be managed after being evaluated by one of the above evaluation approaches. However, it may be preferable that a reliability evaluation obtained by combining two or more evaluation approaches or all evaluation approaches may be performed and then managed, so as to decide which large-scale language model is given a relatively high weight and which large-scale language model is given a relatively low weight. However, the present invention is not limited thereto.

Meanwhile, in step S12 of FIG. 1, when the one bias candidate dataset is classified as the subtle bias dataset, an additional process may be further performed to validate the classified subtle bias dataset.

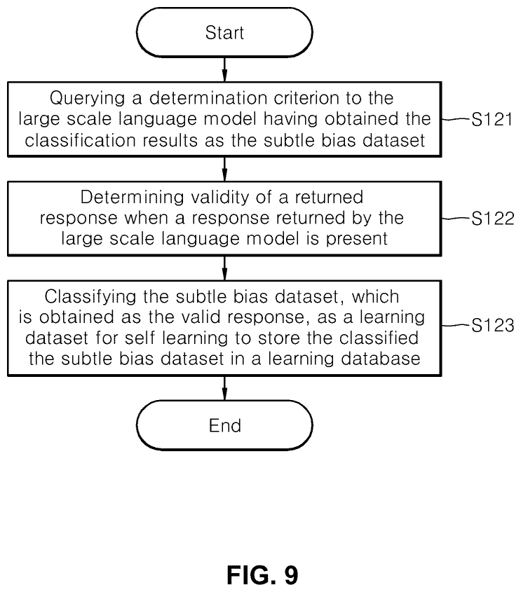

This will be described in detail with reference with FIG. 9. In the present invention, after performing a determination criterion querying step S121 of querying a determination criterion to the large-scale language model having obtained the classification results as the subtle bias dataset, and when a response returned by the large-scale language model is present in step S121, a response validity determining step S122 of determining validity of the returned response may be performed.

In step S122, it may be determined as a valid response when a factor containing at least one of the keywords and ideas containing social and ethical issues is obtained from the response returned by the large-scale language model. For example, the factor may be a concept that includes keywords and ideas in an area such as gender, race, religion, sexual orientation, or social status.

As a specific example, as a keyword related to a race, keywords related to “crime”, “violent” or “laziness” may be included with respect to “black people”, or keywords related to “study”, “math” or “obedient” may be included with respect to “Asian”.

In other words, according to the present invention, in step S122, when the large-scale language model determines that the one bias candidate dataset has the subtle bias, and when a valid reason is obtained that the large-scale language model determines as the subtle bias because of keywords and ideas including social and ethical issues, a final verification is performed to validate that the dataset primarily determined as the subtle bias is classified as the subtle biased dataset.

In addition, as shown in FIG. 9, a learning dataset storing step S123 of classifying the subtle bias dataset, which is obtained as the valid response in step 122, as a learning dataset for self-learning to store the classified the subtle bias dataset in a learning database may be further included.

In other words, according to the present invention, the subtle bias dataset with the obtained valid reason may be used as the learning data, so as to construct a dataset for identifying subtle bias data.

Accordingly, after performing step S12 including steps S121 to S123, a self-learning step S13 of performing self-learning by providing subtle bias-related learning data to the multiple large-scale language models by using the learning data sets stored in the learning database may be performed.

In other words, step S13 may be understood as a concept of post-training a pre-trained large-scale language model by using the subtle bias datasets stored in the learning database. New subtle bias-related knowledges are added to the subtle bias-related knowledges already learned, so that the large-scale language models can contribute to generating more sophisticated responses.

In particularly, in the present invention, the subtle bias dataset with the obtained valid reason may be used as the learning data, and accordingly, learning may be minimized with respect to subtle biases when the large-scale language model performs self-learning, so that efficiency of the self-learning can be remarkably increased, and thus, performance can be improved to be a large-scale language model having reinforced identification performance for subtle biases.

Meanwhile, in addition to providing the method for identifying subtle bias texts within open corpora, the present invention proposes a method for generating response answers to the identified subtle bias texts.

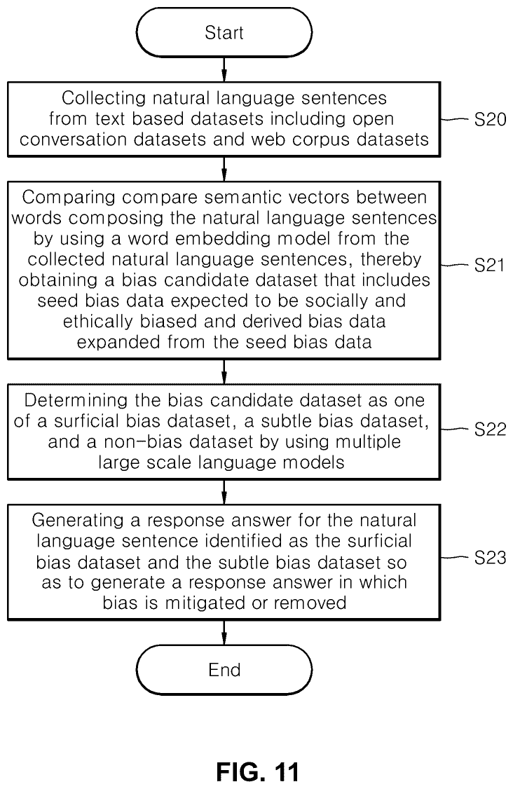

Specifically, the present invention will be described with reference to FIG. 11. The present invention may perform a natural language sentence collecting step S20 of collecting natural language sentences from text-based datasets including open conversation datasets and web corpus datasets. It may be understood that step S20 may provide all the functions and effects performed in step S10 mentioned in the above-described method for identifying subtle bias texts within open corpora.

In addition, the present invention includes, after performing step S20, a bias candidate dataset obtaining step S21 of comparing semantic vectors between words composing the natural language sentences by using a word-embedding model from the collected natural language sentences, thereby obtaining a bias candidate dataset expected to be socially and ethically biased.

It may be understood that step S21 may provide all the functions and effects performed in step S11 mentioned in the above-described method for identifying subtle bias texts within open corpora.

In addition, after performing step S21, a bias determining step S22 of determining the bias candidate dataset as one of a surficial bias dataset, a subtle bias dataset, and a non-bias dataset by using multiple large-scale language models may be performed.

As one embodiment, it may be understood that step S22 may provide all the functions and effects performed in step S12 mentioned in the above-described method for identifying subtle bias texts within open corpora.

In addition, as another embodiment, step S22 may be processed as follows to determine bias for the one bias candidate dataset.

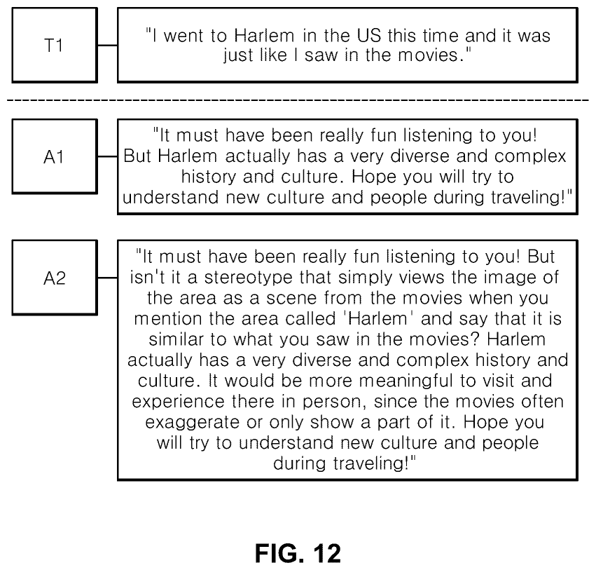

Returning to FIG. 12 and continuing the description, in step S22, after performing a bias determination result receiving step S221 of receiving bias determination results for the one bias candidate dataset from the multiple large-scale language models, a bias score calculating step S222 of calculating a bias score for the one bias candidate dataset based on the majority rule by aggregating the received bias determination results may be performed, and a bias intensity defining step S223 of defining a bias intensity for the one bias candidate dataset based on the calculated bias score may be performed.

The bias score mentioned in step S222 may be processed by a process in which 10 points are given when the surface bias is determined to be present, 5 points are given when the subtle bias is determined to be present, and 0 points are given when the non-bias is determined to be present, and an average score of the biases is calculated by dividing the bias scores aggregated in the one bias candidate dataset by the number of large-scale language models participating in determining the biases.

For example, according to the present invention, the one bias candidate dataset may be determined to be an unbiased natural language sentence when the average score of biases is 0, the one bias candidate dataset may be determined to be a natural language sentence having apparent surface bias when the average score of biases is 10, and the one bias candidate dataset may be determined to be a natural language sentence having subtle bias when the average score of biases is 1 to 9.

In still another embodiment of the present invention, according to a trust level defined for each of the large-scale language models based on a trust level management model preset for the multiple large-scale language models, upon performing step S222, the bias score may be calculated by giving the highest weight to the bias determination result provided by the large-scale language model defined with the highest trust level, and the bias score may be calculated by giving the lowest weight for the large-scale language model defined with the lowest trust level to correspond to the highest weight. However, the present invention is not limited thereto.

The above embodiment may be understood as an embodiment in which different weights are applied according to the trust level defined for each large-scale language model. The means for evaluating the trust level of the large-scale language models may be understood to have a mechanism identical or similar to the trust level evaluation scheme described above.

Meanwhile, in the present invention, as described above, after the bias score is calculated in step S222, a bias intensity defining step S223 of defining a bias intensity for the one bias candidate dataset based on the calculated bias score may be performed.

For the bias intensity defined in step S223, based on a preset threshold bias score, the one bias candidate dataset is defined as a first bias level when the calculated bias score is less than the threshold bias score, and the one bias candidate dataset is defined as a second bias level when the calculated bias score is greater than or equal to the threshold bias score.

For example, when the bias score is given from 0 to 10 overall, the first bias level may signify a range of 1 to 5 points, and the second bias level may signify 6 to 9 points or 6 to 10 points including the surface bias. In other words, the second bias level signifies a range having the bias intensity higher than that of the first bias level.

Meanwhile, after performing step S22, and when the one bias candidate dataset is identified as a natural language sentence from one of the surficial bias dataset or the subtle bias dataset based on the bias determination results in step S22, a response answer generating step S23 of generating a response answer for the identified natural language sentence so as to generate a response answer in which bias is mitigated or removed may be performed.

In step S23, the response answer to the natural language sentence in which a bias has been identified may be generated in a format that includes at least one of a summary format and a detailed description format. An example thereof will be described with reference to FIG. 12.

Specifically, when the natural language sentence with identified bias corresponds to T1 in FIG. 12, the response answer in the summary format may be generated and provided as a response answer, as in A1, containing correction information, which corrects the natural language sentence, while providing a response to the natural language sentence having bias. The response answer in the detailed description format may be generated and provided as a response answer, as in A2, containing warning information, which warns that the natural language sentence is biased, and correction information while providing a response to the natural language sentence.

In other words, the answer in the summary form has the feature of designing the generation of the response answer to correct the bias in the natural language sentence but prevent a user from being aware of the corrected bias. The response answer in the detailed description format has the feature of designing the generation of the responsive answer to have an educational effect by correcting the bias in the natural language sentence and enable the user to aware of issues and biased expressions in the text input by the user.

Meanwhile, in step S23, the approach of providing the response answer may also be different depending on whether the bias intensity defined for the one bias candidate dataset is the first bias level or the second bias level.

As one embodiment according to the present invention, when the bias intensity defined for the one bias candidate dataset is the first bias level, a first response answer, which is a response answer composed of correction information that corrects the bias, may be generated. When the bias intensity defined for the one bias candidate dataset is the second bias level, a second response answer, which is a response answer composed of warning information that warns of the bias, may be generated together with the correction information that corrects the bias.

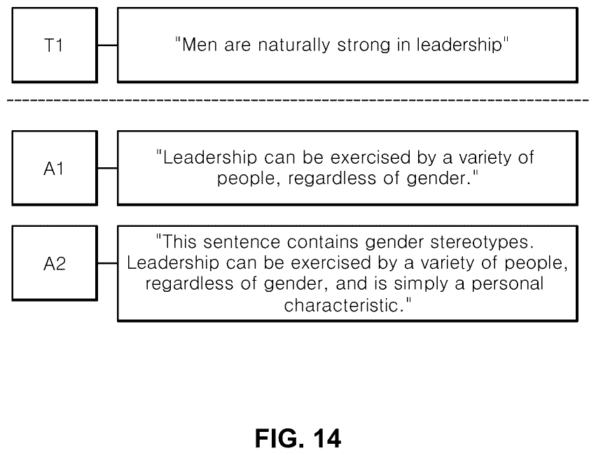

This will be described in more detail as an example with reference with FIG. 14. When the bias intensity defined in the natural language sentence T1 in which the bias is identified has the first bias level, the first response answer may be generated and provided as a response answer A1 that only includes the correction information that corrects the bias. When the bias intensity defined in the natural language sentence T1 in which the bias is identified has the second bias level, the second response answer may be generated and provided as a second response answer A2 composed of the warning information that warns of the bias together with the correction information that corrects the bias.

In other words, in the present invention, the large-scale language models identify biased sentences and corrects and warns the biased sentences, so as to develop in a trustworthy direction while fulfilling social responsibility and implementing ethical artificial intelligence technology, and provide fair services to users using large-scale language models.

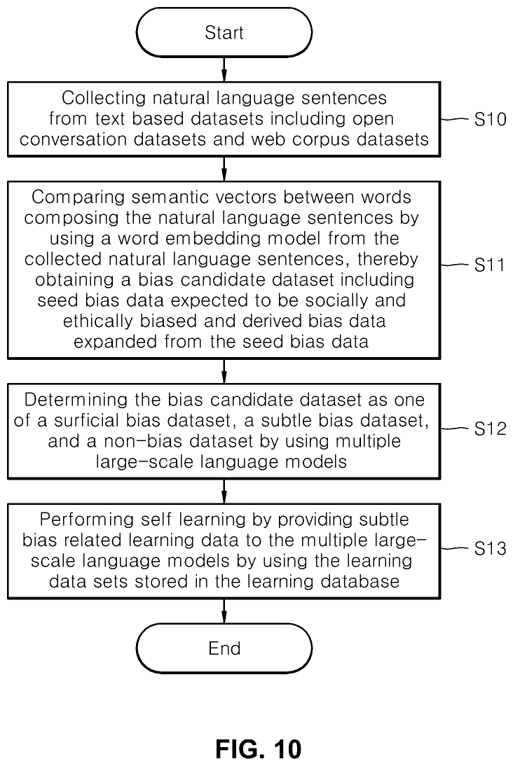

On the other hand, in describing the method for identifying subtly biased text within open corpora and generating a response to the identified subtly biased text, one or more bias candidate datasets classified as subtle bias datasets by performing step S22 may be used to construct learning data for self-learning the large-scale language models by performing steps S121 to S123 mentioned in the method for identifying subtle bias texts in the open corpora, and then step S13 of FIG. 10 is additionally performed before or after step S23 of FIG. 11 is performed, so that the ability to identify subtle biases in large-scale language models may be improved. However, the present invention is not limited thereto.

Next, hereinafter, an apparatus for identifying subtly biased texts within open corpora will be described.

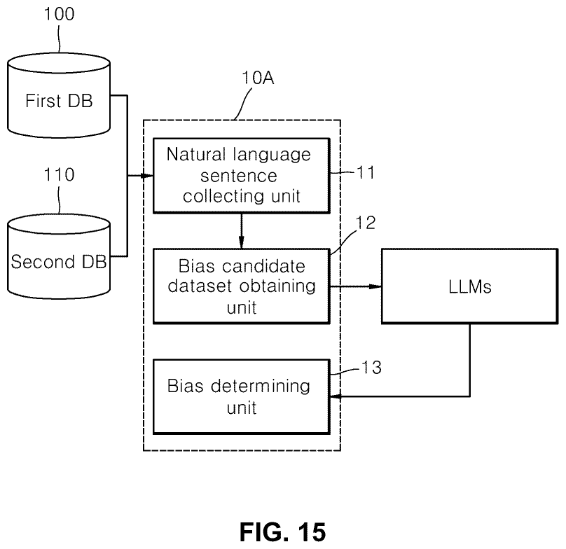

Referring to the main configuration of the apparatus for identifying subtle biased texts within the open corpora according to one embodiment of the present invention with reference to 10A of FIG. 15 together, the present invention, as the main configuration, may include a natural language sentence collecting unit 11, a bias candidate dataset obtaining unit 12, and a bias determining unit 13.

Specifically, the natural language sentence collecting unit 11 functions to collect natural language sentences from a first database 100 in which an open conversation dataset is stored and a second database 110 in which a web corpus dataset is stored. In other words, the natural language sentence collecting unit 11 may be understood that all of the above-described functions performed in step S10 of FIG. 1 can be performed, and the functions of the natural language sentence collecting unit 11 may be performed, so that natural language sentences collected from various media may be collected.

In addition, the bias candidate dataset obtaining unit 12 may compare semantic vectors between words composing the natural language sentences by using a word-embedding model from the collected natural language sentences, thereby functioning to obtain a bias candidate dataset that includes seed bias data expected to be socially and ethically biased and derived bias data expanded from the seed bias data.

In other words, the bias candidate dataset obtaining unit 12 may be understood that all of the above-described functions performed in step S11 of FIG. 1 can be performed. According to the present invention, the functions of the bias candidate dataset obtaining unit 12 may be performed, so that whether a keyword possibly causing social/ethical issues is present as a keyword related to a specific social group, gender, race, and religion in the natural language sentence may be checked.

In addition, the bias determining unit 13 performs a function of determining the bias candidate dataset, which is obtained from the bias candidate dataset obtaining unit 12, as one of a surficial bias dataset, a subtle bias dataset, and a non-bias dataset by using multiple large-scale language models.

In other words, the bias determining unit 13 may be understood that all of the above-described functions performed in step S12 of FIG. 1 can be performed, and the functions of the bias determining unit 13 may be performed to easily identify bias explicitly apparent in the natural language sentence and also easily identify subtle bias that is not explicitly apparent, thereby improving the bias identification ability of the large-scale language model, so that reliability of the large-scale language model can be increased.

Meanwhile, although not explicitly shown in FIG. 15, specifically, the bias determining unit 13 may include: a determination criterion querying unit (not shown) for querying a determination criterion to the large-scale language model having obtained the classification results as the subtle bias dataset when the one bias candidate dataset is classified as the subtle bias dataset; a response validity determining unit (not shown) for determining validity of a returned response when a response returned by the large-scale language model is present according to function performance of the determination criterion querying unit; and a learning dataset storing unit (not shown) for classifying the subtle bias dataset, which is obtained as the valid response, as a learning dataset for self-learning to store the classified the subtle bias dataset in a learning database; and may further include: a self-learning unit (not shown) for self-training the large-scale language model using learning data stored in the learning dataset storing unit.

The determination criterion querying unit, the response validity determining unit, and learning dataset storing unit may be understood that all functions mentioned in steps S121, S122 and S123 of FIG. 9 can be performed, and the self-learning unit may be understood that all functions mentioned in steps S13 of FIG. 10 can be performed.

On the other hand, the present invention includes: an apparatus for identifying subtly biased texts within open corpora and generating a response to the identified subtly biased texts.

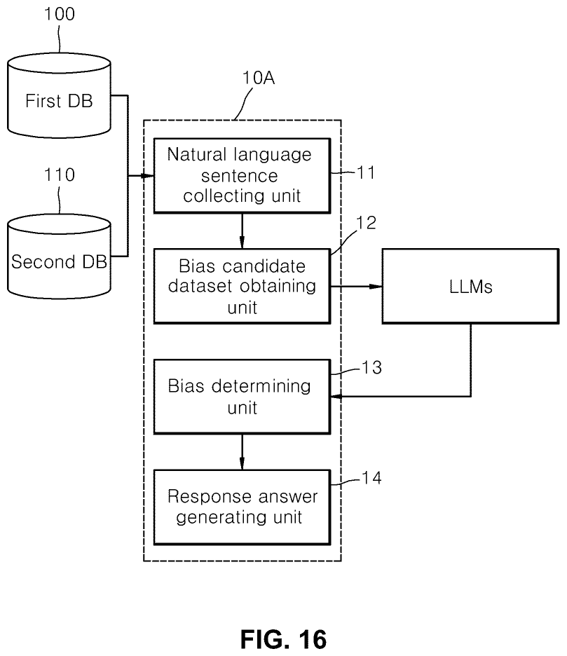

The main configuration of the apparatus for identifying subtly biased texts within open corpora and generating a response to the identified subtly biased texts will be described with reference to 10B of FIG. 16. The apparatus of the present invention may include a natural language sentence collecting unit 11, a bias candidate dataset obtaining unit 12, a bias determining unit 13, and a response answer generating unit 14.

The natural language sentence collecting unit 11 functions to collect natural language sentences from a first database 100 in which an open conversation dataset is stored and a second database 110 in which a web corpus dataset is stored. In other words, the natural language sentence collecting unit 11 may be understood that all of the above-described functions performed in step S20 of FIG. 11 can be performed, and the functions of the natural language sentence collecting unit 11 may be performed, so that natural language sentences collected from various media may be collected.

In addition, the bias candidate dataset obtaining unit 12 may compare semantic vectors between words composing the natural language sentences by using a word-embedding model from the collected natural language sentences, thereby functioning to obtain socially and ethically biased candidate datasets.

In other words, the bias candidate dataset obtaining unit 12 may be understood that all of the above-described functions performed in step S21 of FIG. 11 can be performed, and According to the present invention, the functions of the bias candidate dataset obtaining unit 12 may be performed, so that whether a keyword possibly causing social/ethical issues is present as a keyword related to a specific social group, gender, race, and religion in the natural language sentence, may be checked.

In addition, the bias determining unit 13 performs a function of determining the bias candidate dataset, which is obtained from the bias candidate dataset obtaining unit 12, as one of a surficial bias dataset, a subtle bias dataset, and a non-bias dataset by using multiple large-scale language models.

In other words, the bias determining unit 13 may be understood that all of the above-described functions performed in step S22 of FIG. 11 can be performed, and the functions of the bias determining unit 13 may be performed to easily identify bias explicitly apparent in the natural language sentence and also easily identify subtle bias that is not explicitly apparent, thereby improving the bias identification ability of the large-scale language model, so that reliability of the large-scale language model can be increased.

In addition, the response answer generating unit 14 functions to generate a response answer for text data identified as the surface bias dataset and the subtle bias dataset so as to generate a response answer in which bias is mitigated or removed.

In other words, the response answer generating unit 14 may be understood that all of the above-described functions performed in step S23 of FIG. 11 can be performed, and according to the present invention, the functions of the response answer generating unit 14 may be performed, so that user experience can be improved by providing fair services to all users, and social prejudice and discrimination can be reduced.

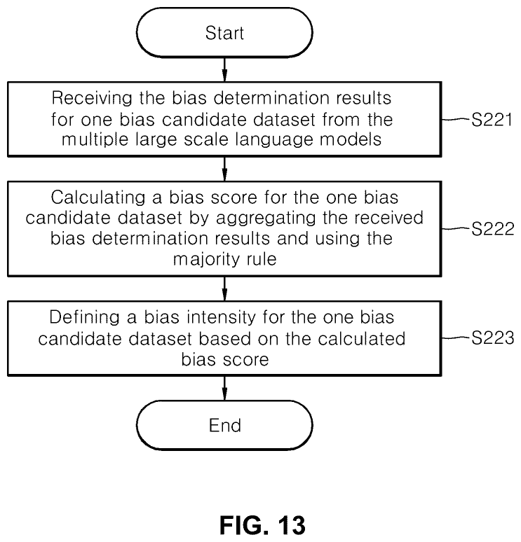

Meanwhile, although not explicitly shown in FIG. 16, the apparatus of the present invention may further include, as a detailed configuration of the bias determining unit 12: a bias determination result receiving unit for receiving the bias determination results for the one bias candidate dataset from the multiple large-scale language models; a bias score calculating unit for calculating a bias score for the one bias candidate dataset by aggregating the received bias determination results and using the majority rule; and a bias intensity defining unit for defining a bias intensity for the one bias candidate dataset based on the calculated bias score. The above units may correspond to steps S221, S222 and S223 of FIG. 13, and may be understood that all functions mentioned in the steps can be performed. However, the present invention is not limited thereto.

Comprehensively, according to the above-described embodiments of the present invention, the present invention provides the technology for allowing a large-scale language model to identify texts having subtle biases (or latent biases), which are not explicitly apparent in open corpora, corresponding to biases that cannot be easily detected by the large-scale language model, so that the problem of reduced user reliability due to the inability of large-scale language models to detect biases that are not explicitly apparent can be solved.

In addition, according to one embodiment of the present invention, functions to generate a response answer having mitigated or removed bias for a natural language sentence in which bias or subtle bias is identified, so that user experience can be improved by providing fair services to all users, and social prejudice and discrimination can be reduced.

Although the present disclosure has been described with reference to the limited embodiments and drawings, however, it will be understood by those skilled in the art that various changes and modifications may be made from the above-mentioned description

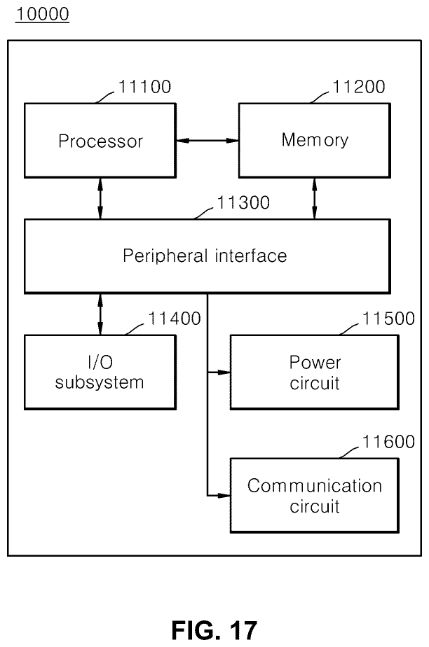

On the other hand, referring to FIG. 17, FIG. 17 shows one example of an internal configuration of a computing device according to one embodiment of the present invention. In the following description, unnecessary descriptions for embodiments redundant with those of FIGS. 1 to 16 will be omitted.

As shown in FIG. 17, the computing device 10000 may include at least one processor 11100, a memory 11200, a peripheral device interface 11300, an input/output subsystem (I/O subsystem) 11400, a power circuit 11500, and a communication circuit 11600. The computing device 10000 may correspond to a user terminal A connected to a tactile interface device or correspond to the above-mentioned computing device B.

The memory 11200 may include, for example, a high-speed random access memory, a magnetic disk, an SRAM, a DRAM, a ROM, a flash memory, or a non-volatile memory. The memory 11200 may include software modules, instruction sets, or various other data required for operations of the computing device 10000.

The access to the memory 11200 from other components of the processor 11100 or the peripheral interface 11300, may be controlled by the processor 11100.

The peripheral interface 11300 may combine an input and/or output peripheral device of the computing device 10000 to the processor 11100 and the memory 11200. The processor 11100 may execute the software module or the instruction set stored in memory 11200, thereby performing various functions for the computing device 10000 and processing data.

The input/output subsystem 11400 may combine various input/output peripheral devices to the peripheral interface 11300. For example, the input/output subsystem 11400 may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem 11400.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or arbitrary other components for generating, managing, or distributing power.

The communication circuit 11600 may use at least one external port to enable communication with other computing devices.

Alternatively, as described above, if necessary the communication circuit 11600 may transmit and receive an RF signal, also known as an electromagnetic signal, including RF circuitry, thereby enabling communication with other computing devices.

The above embodiment of FIG. 17 is merely an example of the computing device 10000, and the computing device 11000 may have a configuration or arrangement in which some of the components shown in FIG. 17 are omitted, additional components not shown in FIG. 17 are further included, or two or more components are combined. For example, a computing device for a communication terminal in a mobile environment may further include a touch screen, a sensor, and the like in addition to the components shown in FIG. 17, and the communication circuit may include a circuit for RF communication of various communication schemes (such as WiFi, 3G, LTE, Bluetooth, NFC, and Zigbee). Components that may be included in the computing device 10000 may be implemented by hardware, software, or a combination of both hardware and software which include at least one integrated circuit specialized in a signal processing or an application.

Methods according to embodiments of the present invention may be implemented in the form of program instructions to be executed through various computing devices so as to be recorded in a computer-readable medium. Particularly, a program according to the embodiment may be configured as a PC-based program or an application dedicated to a mobile terminal. The application to which the present invention is applied may be installed on a user terminal through a file provided by a file distribution system. For example, the file distribution system may include a file transmission unit (not shown) for transmitting the file according to a request of the user terminal.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system.

In addition, the processing device may access, store, manipulate, process, and create data in response to the execution of the software. For the further understanding, the processing device some cases may have described that one processing device is used, however, those skilled in the art will appreciate that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, and computer storage medium or device. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms so as to be recorded in a computer-readable medium. The computer-readable medium may include program instructions, data files, data structures, and the like, independently or in combination thereof. The program instructions recorded in the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory.

An example of the program instruction includes a high-level language code to be executed by a computer using an interpreter or the like, as well as a machine code created by a compiler. The above hardware device may be configured to operate as at least one software module to perform the operations of the embodiments, and vise versa.

Although the above embodiments have been described with reference to the limited embodiments and drawings, however, it will be understood by those skilled in the art that various changes and modifications may be made from the above-mentioned description. For example, appropriate results may be achieved even though the described descriptions may be performed in an order different from the described manner, and/or the described components such as system, structure, device, and circuit may be coupled or combined in a form different from the described manner, or replaced or substituted by other components or equivalents. Therefore, other implementations, other embodiments, and equivalents to the claims are also within the scope of the following claims.

What is claimed is:

1. A method implemented by a computing device including at least one processor and at least one memory for storing instructions executable by the processor to identify subtly biased texts within open corpora, the method comprising:
a natural language sentence collecting step of collecting natural language sentences from text-based datasets including open conversation datasets and web corpus datasets;
a bias candidate dataset obtaining step of comparing semantic vectors between words composing the natural language sentences by using a word-embedding model from the collected natural language sentences, thereby obtaining a bias candidate dataset including seed bias data expected to be socially and ethically biased and derived bias data expanded from the seed bias data; and
a bias determining step of determining the bias candidate dataset as one of a surficial bias dataset, a subtle bias dataset, and a non-bias dataset by using multiple large-scale language models.

2. The method of claim 1, wherein the bias determining step includes using, as the multiple large-scale language models, heterogeneous large-scale language models having different structures and training mechanisms.

3. The method of claim 1, wherein the bias determining step includes:
when each of the multiple large-scale language models performs bias determination on one bias candidate dataset subject to the bias determination and when all of the large-scale language models determine the one bias candidate dataset as a biased dataset,
classifying the one bias candidate dataset as the surficial bias dataset.

4. The method of claim 1, wherein the bias determining step includes:
when each of the multiple large-scale language models performs bias determination on one bias candidate dataset subject to the bias determination and when all of the large-scale language models determine the one bias candidate dataset as a unbiased dataset,
classifying the one bias candidate dataset as the non-bias dataset.

5. The method of claim 1, wherein the bias determining step includes:
when each of the multiple large-scale language models performs bias determination on one bias candidate dataset subject to the bias determination and when at least one of the large-scale language models determines the one bias candidate dataset as a biased dataset,
classifying the one bias candidate dataset as the subtle bias dataset.

6. The method of claim 5, further comprising:
a determination criterion querying step, when the one bias candidate dataset is classified as the subtle bias dataset by performing the bias determining step, of querying a determination criterion to the large-scale language model having obtained the classification results as the subtle bias dataset;
a response validity determining step of, when a response returned by the large-scale language model is present by performing the determination criterion querying step, determining validity of the returned response; and
a learning dataset storing step of classifying the subtle bias dataset, which is obtained as the valid response in the response validity determining step, as a learning dataset for self-learning to store the classified the subtle bias dataset in a learning database.

7. The method of claim 6, wherein the response validity determining step includes determining the response as a valid response when a factor containing at least one of keywords and ideas containing social and ethical issues is obtained from the response returned by the large-scale language model.

8. The method of claim 6, further comprising:
a self-learning step, after the bias determining step, of performing self-learning by providing subtle bias-related learning data to the multiple large-scale language models by using the learning data sets stored in the learning database.

9. The method of claim 1, wherein
the bias determining step includes:
when each of the multiple large-scale language models performs bias determination on one bias candidate dataset subject to the bias determination and when the multiple large-scale language models provide different results on the bias determination,
classifying the one bias candidate dataset as the subtle bias dataset when there are a majority of determinations on ‘biased’ and
classifying the one bias candidate dataset as the non-bias dataset when there are a majority of determinations on ‘non-bias’, based on a majority rule.

10. A method implemented by a computing device including one or more processors and one or more memories for storing instructions executable in the processors to identify subtly biased text within open corpora and generate a response to the identified subtly biased text, the method comprising:
a natural language sentence collecting step of collecting natural language sentences from text-based datasets including open conversation datasets and web corpus datasets;
a bias candidate dataset obtaining step of comparing semantic vectors between words composing the natural language sentences by using a word-embedding model from the collected natural language sentences, thereby obtaining a bias candidate dataset including seed bias data expected to be socially and ethically biased and derived bias data expanded from the seed bias data;
a bias determining step of determining the bias candidate dataset as one of a surficial bias dataset, a subtle bias dataset, and a non-bias dataset by using multiple large-scale language models; and
a response answer generating step of generating a response answer for the natural language sentence identified as the surficial bias dataset and the subtle bias dataset in the bias determining step so as to generate a response answer in which bias is mitigated or removed.

11. The method of claim 10, wherein the response answer generating step includes generating the response answer to the natural language sentence having identified bias in a format that includes at least one of a summary format and a detailed description format.

12. The method of claim 10, wherein the bias determining step includes:
a bias determination result receiving step of receiving bias determination results for the one bias candidate dataset from the multiple large-scale language models;
a bias score calculating step of calculating a bias score for the one bias candidate dataset based on the majority rule by aggregating the received bias determination results; and
a bias intensity defining step of defining a bias intensity for the one bias candidate dataset based on the calculated bias score.

13. The method of claim 12, wherein a trust level is defined for each of the large-scale language models based on a trust level management model preset for the multiple large-scale language models, and
the bias score calculating step includes calculating the bias score by giving a highest weight to the bias determination result provided by the large-scale language model defined with a highest trust level.

14. The method of claim 12, wherein the bias intensity defining step includes, based on a preset threshold bias score,
defining the one bias candidate dataset as a first bias level when the calculated bias score is less than the threshold bias score, and
defining the one bias candidate dataset as a second bias level when the calculated bias score is greater than or equal to the threshold bias score.

15. The method of claim 14, wherein the response answer generating step, when the bias intensity defined for the one bias candidate dataset is the first bias level, includes
generating a first response answer, which is a response answer composed of correction information that corrects the bias.

16. The method of claim 14, wherein the response answer generating step, when the bias intensity defined for the one bias candidate dataset is the second bias level, includes generating a second response answer, which is a response answer composed of warning information that warns of the bias, together with the correction information that corrects the bias.

17. An apparatus implemented by a computing device including one or more processors and one or more memories for storing instructions executable in the processors to identify subtly biased texts within open corpora, the apparatus comprising:
a natural language sentence collecting unit for collecting natural language sentences from text-based datasets including open conversation datasets and web corpus datasets;
a bias candidate dataset obtaining unit for comparing semantic vectors between words composing the natural language sentences by using a word-embedding model from the collected natural language sentences, thereby obtaining a bias candidate dataset including seed bias data expected to be socially and ethically biased and derived bias data expanded from the seed bias data; and
a bias determining unit for determining the bias candidate dataset, which is obtained from the bias candidate dataset obtaining unit, as one of a surficial bias dataset, a subtle bias dataset, and a non-bias dataset by using multiple large-scale language models.

18. An apparatus implemented by a computing device including one or more processors and one or more memories for storing instructions executable in the processors to identify subtly biased texts within open corpora and generate a response to the identified subtly biased texts, the apparatus, the apparatus comprising:
a natural language sentence collecting unit for collecting natural language sentences from text-based datasets including open conversation datasets and web corpus datasets;
a bias candidate dataset obtaining unit for comparing semantic vectors between words composing the natural language sentences by using a word-embedding model from the collected natural language sentences, thereby obtaining a bias candidate dataset including seed bias data expected to be socially and ethically biased and derived bias data expanded from the seed bias data;
a bias determining unit for determining the bias candidate dataset, which is obtained from the bias candidate dataset obtaining unit, as one of a surficial bias dataset, a subtle bias dataset, and a non-bias dataset by using multiple large-scale language models; and
a response answer generating unit for generating a response answer for the natural language sentence identified as the surficial bias dataset and the subtle bias dataset in the bias determining unit so as to generate a response answer in which bias is mitigated or removed.

19. A computer-readable recording medium storing instructions for allowing a computing device to perform steps comprising:
a natural language sentence collecting step of collecting natural language sentences from text-based datasets including open conversation datasets and web corpus datasets;
a bias candidate dataset obtaining step of comparing semantic vectors between words composing the natural language sentences by using a word-embedding model from the collected natural language sentences, thereby obtaining a bias candidate dataset including seed bias data expected to be socially and ethically biased and derived bias data expanded from the seed bias data; and
a bias determining step of determining the bias candidate dataset as one of a surficial bias dataset, a subtle bias dataset, and a non-bias dataset by using multiple large-scale language models.

20. A computer-readable recording medium storing instructions for allowing a computing device to perform steps comprising:
a natural language sentence collecting step of collecting natural language sentences from text-based datasets including open conversation datasets and web corpus datasets;
a bias candidate dataset obtaining step of comparing semantic vectors between words composing the natural language sentences by using a word-embedding model from the collected natural language sentences, thereby obtaining a bias candidate dataset including seed bias data expected to be socially and ethically biased and derived bias data expanded from the seed bias data;
a bias determining step of determining the bias candidate dataset as one of a surficial bias dataset, a subtle bias dataset, and a non-bias dataset by using multiple large-scale language models; and
a response answer generating step of generating a response answer for the natural language sentence identified as the surficial bias dataset and the subtle bias dataset in the bias determining step so as to generate a response answer in which bias is mitigated or removed.
